(19) United States
(12) Patent Application Publication
(10) Pub. No.: US 2017/0219175 A1
(43) Pub. Date: Aug. 3, 2017

(54) LIGHTING APPARATUS

(71) Applicant: PANASONIC INTELLECTUAL PROPERTY MANAGEMENT CO., LTD., Osaka (JP)

(72) Inventors: Tohru HIMENO, Osaka (JP); Makoto YAMADA, Osaka (JP); Shinichi AOKI, Osaka (JP); Hideki WADA, Osaka (JP)

(73) Assignee: PANASONIC INTELLECTUAL PROPERTY MANAGEMENT CO., LT D., Osaka (JP)

(21) Appl. No.: 15/419,163

(22) Filed: Jan. 30, 2017

(30) Foreign Application Priority Data
Feb. 2, 2016 (JP) 2016-018362

(51) Int. Cl. F21S 8/08; F21V 15/01; F21V 21/116; F21V 3/04; F21V 11/16; F21V 5/04

(52) U.S. Cl. CPC F21S 8/086; F21V 11/16; F21V 5/04; F21V 21/116; F21V 3/0445; F21V 15/01; F21Y 2103/20

(57) ABSTRACT

A lighting apparatus to be installed in an area adjacent to land is provided. The lighting apparatus includes a plurality of light sources disposed on a board and further includes a light shield. The light shield blocks a portion of light emitted from the light sources. The portion of light has a predetermined wavelength. The light shield is disposed on the board closer to the land than at least a light source disposed closest to the land among the light sources. The light shield has a shape which sends, to the land, first emission light included in the light emitted from the light sources. The shape avoids sending, to the land, second emission light included in the light emitted from the light sources. The first emission light passes through the light shield. The second emission light does not pass through the light shield.

### CROSS REFERENCE TO RELATED APPLICATION

This application claims the benefit of priority of Japanese Patent Application Number 2016-018362 filed on Feb. 2, 2016, the entire content of which is hereby incorporated by reference.

### BACKGROUND

1. Technical Field

The present disclosure relates to a lighting apparatus.

2. Description of the Related Art

Conventionally, a lighting apparatus such as an outdoor lump, a security lamp, or the like, for use during night-time, is installed in a street space, a road space, and the like in order to ensure visibility of pedestrians or drivers of vehicles (for example, Japanese Unexamined Patent Application Publication No. 2012-227041). The lighting apparatus disclosed by Japanese Unexamined Patent Application Publication No. 2012-227041 includes a bottom irradiation part and an upper irradiation part, thereby reducing unnecessary glare and a feeling of discomfort felt by a human while ensuring visibility.

### SUMMARY

However, when a plant which shows a photoperiodic reaction, such as a long-day plant and a short-day plant, is irradiated with light emitted from a lighting apparatus during night-time, the photoperiodism is disturbed, and the plant is subject to light pollution of which flower-bud formation is suppressed or promoted. This poses a problem of a decreased quality or decreased crop yields, to crops cultivated in proximity to a space in which a lighting apparatus is installed.

In view of the above, an object of the present disclosure is to provide a lighting apparatus capable of suppressing occurrence of light pollution that affects crops.

A lighting apparatus according to an aspect of the present disclosure is a lighting apparatus to be installed in an area adjacent to land. The lighting apparatus includes: a plurality of light sources disposed on a board; and a light shield which blocks a portion of light emitted from the plurality of light sources, the portion of light having a predetermined wavelength, wherein the light shield is disposed on the board closer to the land than at least a light source disposed closest to the land among the plurality of light sources, and has a shape which (i) sends, to the land, first emission light included in the light emitted from the plurality of light sources, and (ii) avoids sending, to the land, second emission light included in the light emitted from the plurality of light sources, the first emission light having passed through the light shield, the second emission light not having passed through the light shield.

The lighting apparatus according to the present disclosure is capable of suppressing occurrence of light pollution that affects crops.

### BRIEF DESCRIPTION OF DRAWINGS

The figures depict one or more implementations in accordance with the present teaching, by way of examples only, not by way of limitations. In the figures, like reference numerals refer to the same or similar elements.

FIG. 1 is a diagram illustrating a state in which a lighting apparatus according to an embodiment is used;

FIG. 2 is a perspective view illustrating a configuration of the lighting apparatus according to the embodiment;

FIG. 3 is a schematic view illustrating a configuration of the lighting apparatus according to the embodiment;

FIG. 4 is a diagram indicating a wavelength region of light to which phytochrome of a Pr state reacts;

FIG. 5 is a diagram illustrating a ratio of radiant energy of a wavelength in a range from 550 nm or greater and 710 nm or less with respect to a correlated color temperature;

FIG. 6 is a diagram illustrating an example of an emission direction of first emission light and an emission direction of second emission light of the lighting apparatus according to the embodiment;

FIG. 7 is a schematic view illustrating a configuration of a lighting apparatus according to Modification 1; and

FIG. 8 is a schematic view illustrating a configuration of a lighting apparatus according to Modification 2.

### DETAILED DESCRIPTION OF THE EMBODIMENT

Hereinafter, an embodiment of the present disclosure shall be described with reference to the drawings. It should be noted that the embodiment described below shows a general or specific example. The numerical values, shapes, materials, structural components, and the disposition and connection of the structural components, etc. described in the following embodiment are mere examples, and do not intend to limit the present disclosure. Therefore, among the structural components in the following embodiment, structural components not recited in any one of the independent claims are described as arbitrary structural components.

In addition, each of the diagrams is a schematic diagram and thus is not necessarily strictly illustrated. In each of the diagrams, substantially the same structural components are assigned with the same reference signs, and there are instances where redundant descriptions are omitted or simplified.

### Embodiment

[Outline]

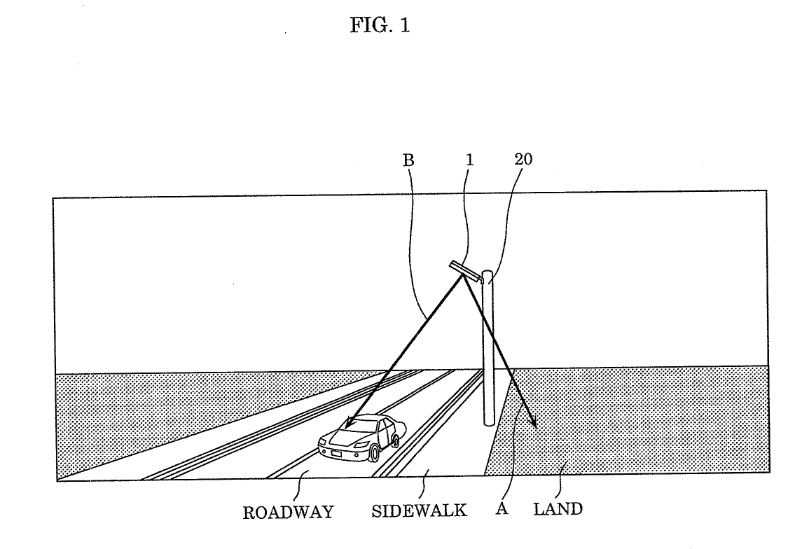

First, an outline of a lighting apparatus according to the present embodiment shall be described. FIG. 1 is a diagram illustrating a state in which lighting apparatus 1 according to the present embodiment is used.

Lighting apparatus 1 according to the present embodiment is a lighting apparatus such as an outdoor lump and a security lamp used during night-time in a street space, a road space, and the like as illustrated in FIG. 1. More specifically, lighting apparatus 1 according to the present embodiment is assumed to be a lighting apparatus installed at an edge of a road such as a roadway and a sidewalk.

The lighting apparatus installed at the edge of a road illuminates not only the road as indicated by arrow B in FIG. 1 but also land adjacent to the road as indicated by arrow A in FIG. 1 when the land is located adjacent to the road.

In this case, when a plant which shows a photoperiodic reaction is cultivated in the land, the cultivated plant's photoperiodism is disturbed by being illuminated during night-time by the lighting apparatus. The photoperiodism is a phenomenon which occurs in living organisms such as plants, according to a change in the length of daytime (photoperiod) and the length of night-time (dark period).

More specifically, a plant which shows the photoperiodic reaction includes a substance called a red light absorbing state (Pr state) phytochrome, in a cell of a leaf. The Pr-state phytochrome has a property that readily absorbs light having a wavelength in a range from approximately 550 nm or greater to approximately 710 nm or less. Since the Pr-state phytochrome absorbs light which is included in night-time illumination and has a wavelength in a range from approximately 550 nm or greater to approximately 710 nm or less, the photoperiodism of a crop cultivated in proximity to an installation position of a lighting apparatus is disturbed by receiving light during night-time that is a period in which light is not received originally. With this, the crop is subject to light pollution which suppresses or promotes flower-bud formation. This poses, to the crop, problems such as a decreased quality and decreased crop yields.

In order to solve the above-described problems, lighting apparatus 1 according to the present embodiment blocks, using a light shield which blocks light having a predetermined wavelength, a portion of light which is included in light emitted from a light source to crops and has a predetermined wavelength.

Lighting apparatus 1 emits, toward land, light which does not include the portion of light having the predetermined wavelength. In this manner, occurrence of light pollution that affects the crops is suppressed.

The following describes lighting apparatus 1.

[A Configuration of Lighting Apparatus]

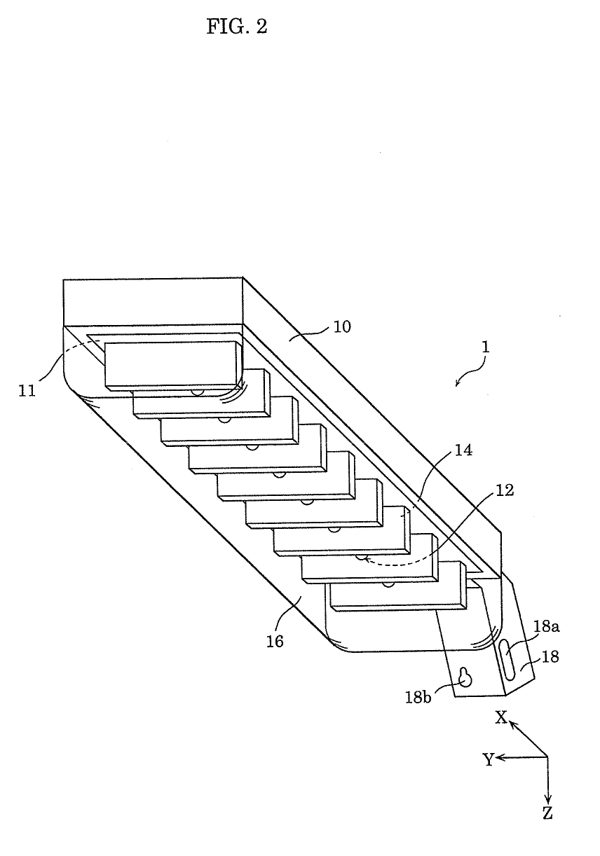

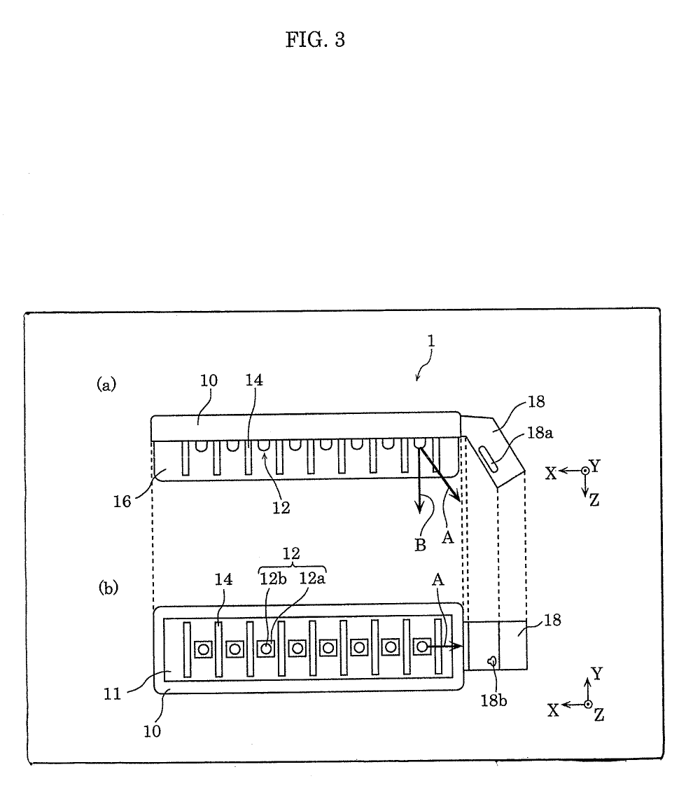

First, a configuration of lighting apparatus 1 according to the present embodiment shall be described. FIG. 2 is a perspective view illustrating a configuration of lighting apparatus 1 according to the present embodiment. FIG. 3 is a schematic view illustrating the configuration of lighting apparatus 1 according to the present embodiment, showing a front view in (a) and a bottom view in (b). It should be noted that illustration of lighting cover 16 is omitted in (b) of FIG. 3.

As illustrated in FIG. 2 and FIG. 3, lighting apparatus 1 includes housing 10 which is an apparatus body, board 11, a plurality of light sources 12, light shield 14, lighting cover 16, attaching component 18, and power supplier (not illustrated).

Housing 10 is a housing for supporting board 11. Housing 10 is formed into a predetermined shape by performing press working on a plate such as an aluminum plate and a steel plate.

Board 11 is a printed circuit board for mounting a plurality of light sources 12, and formed into a rectangular shape in plan view of X-Y plane. On board 11, a wiring pattern (not illustrated) formed of a copper foil pattern is disposed. It should be noted that, a resin board, a metal base board, a ceramic board, a paper phenol board, a glass board, etc. may be used as board 11, for example.

The plurality of light sources 12 each include light-emitting element 12a and optical lens 12b. Light-emitting element 12a is, for example, a packaged white light emitting diode (LED) element of a surface mount device (SMD) type. Light-emitting elements 12a are mounted on the wiring pattern on board 11. Light-emitting elements 12a are, for example, disposed on board 11 linearly in direction X among directions X, Y, and Z illustrated in FIG. 2 and FIG. 3. It should be noted that light-emitting elements 12a may be disposed on board 11 not only linearly but also in any manner.

Light-emitting elements 12a each have a white resin package (container) having a recess, an LED chip primarily mounted on a bottom surface of the recess of the package, and a sealing component sealed in the recess of the package. The LED chip is a blue LED chip which emits blue light, for example. The sealing component contains a yellow phosphor such as yttrium aluminum garnet (YAG) which emits fluorescent light with blue light emitted by a blue LED chip being excitation light.

As described above, light-emitting element 12a is a white LED element of a B—Y type including the blue LED chip and the yellow phosphor. More specifically, the yellow phosphor contained in the sealing component is excited by absorbing part of blue light from the blue LED chip to emit yellow light. The emitted yellow light and blue light not absorbed by the yellow phosphor are mixed, and thereby white light is generated. In this manner, white light is emitted from light-emitting element 12a. The white light emitted from each of light-emitting elements 12a includes light having a wavelength in a range from 380 nm or greater to 780 nm or less, which is a visible wavelength.

Light-emitting element 12a is covered by optical lens 12b. Optical lens 12b is formed using, for example, a light-transmissive component such as an acrylic resin. Light source 12 includes light-emitting element 12a covered by optical lens 12b, and thus is capable of emitting light not only in a direction of an optical axis of light-emitting element 12a but also in a direction perpendicular to the direction of the optical axis, and other directions. It should be noted that light-emitting element 12a may be not covered by optical lens 12b.

The power supplier is a power source which supplies power for causing light sources 12 to emit light and other necessary power for lighting apparatus 1 to operate.

Light shield 14 is a light shield for blocking a portion of light which is included in light emitted from each of the plurality of light sources 12 and has a predetermined wavelength. The predetermined wavelength here is a wavelength of, for example, light to which the Pr-state phytochrome included in a crop reacts.

Light shield 14 has a shape capable of (i) sending, to land, first emission light A which is included in light emitted from the plurality of light sources 12 and has passed through light shield 14, and (ii) avoiding sending, to the land, second emission light B which is included in the light emitted from the plurality of light sources 12 and has not passed through light shield 14. For example, light shield 14 is formed of a plate-like component which has a rectangular shape in an Y-Z plan view.

Light shield 14 is disposed on board 11 closer to the land than at least a light source disposed closest to the land among the plurality of light sources 12 in a direction in which the plurality of light sources 12 are arranged. More specifically, light shield 14 is disposed: closer to the land than light source 12 disposed closest to the land among the plurality of light sources 12; closer to the road than light source 12 disposed closest to the road among the plurality of light sources 12; and between adjacent one of the plurality of light sources 12. In this manner, it is possible to block, in proximity to the plurality of light sources 12, a portion of light having a predetermined wavelength emitted from the plurality of light sources 12. It should be noted that light source 12 only needs to be disposed closer to the land than light source 12 disposed closest to the land. Light shield 14 is placed such that a height direction of light shield 14 and an optical axis direction of light source 12 are parallel to each other. In this manner, it is possible to emit light which includes the portion of light having the predetermined wavelength, at least in the direction of the optical axis.

It should be noted that the length of light shield 14 in direction X among directions of X, Y, and Z indicated in FIG. 2 and FIG. 3 is called a thickness, the length of direction Y is called a width, and the length of direction Z is called a height. More specifically, lighting apparatus 1 includes attaching component 18 which is provided at one end closest to the land and will be described later in detail. In lighting apparatus 1, the direction from the one end closest to the land on which attaching component 18 is disposed toward the other end on which attaching component 18 is not disposed is direction X, and the direction which is orthogonal to direction X on board 11 is direction Y. Furthermore, direction X indicated in FIG. 2 and FIG. 3 is called a thickness direction of light shield 14, direction Y is called a width direction of light shield 14, and direction Z is called a height direction of light shield 14.

In addition, the optical axis direction of light source 12 is the direction of a normal line with respect to board 11; that is, direction Z illustrated in FIG. 2 and FIG. 3. In FIG. 3, examples of an emission direction of first emission light A which has passed through light shield 14 and an emission direction of second emission light B which has not passed through light shield 14 are indicated by arrows. First emission light A indicates an example of light which has passed through an end portion of light shield 14 in the height direction. In addition, second emission light B indicates an example of light traveling in the optical axis direction. Characteristics and a detailed configuration of light shield 14 will be described later in detail.

Lighting cover 16 is an exterior cover for covering the plurality of light sources 12 and the plurality of light shield 14. Lighting cover 16 is formed of a light-transmissive resin material. For example, lighting cover 16 is formed of polymethylmethacrylate (PMMA), polycarbonate (PC), etc. Lighting cover 16 has a flat-plate shape, for example, and is detachably attached to an opening of housing 10. In this manner, the plurality of light sources 12 and the plurality of light shields 14 which are formed on board 11 are housed inside lighting cover 16 (i.e., on the side of housing 10). It should be noted that the shape of lighting cover 16 is not limited to flat-plate shape, and may be a shape having a curved surface.

Attaching component 18 is a component for attaching lighting apparatus 1 to support column 20 (see FIG. 1) installed on a road. Attaching component 18 is joined to housing 10 at one end of lighting apparatus 1 closest to the land, for example. Lighting apparatus 1 is installed on support column 20 by fixing attaching component 18 to support column 20 with, for example, a support column attaching belt (not illustrated), a fixture (not illustrated), and a bolt (not illustrated). Attaching component 18 includes belt hole 18a for passing through the support column attaching belt and threaded hole 18b for fixing to the fixture, is fixed by the bolt to the fixture attached by the belt to the support column, and is fixed to the support column by the support column attaching belt. It should be noted that, support column 20 may be a dedicated support column for lighting apparatus 1, or other support columns such as a power pole. A position of attaching lighting apparatus 1 to support column 20 will described later in detail.

With the above-described configuration, lighting apparatus 1 emits, toward the land, first emission light A which is included in light emitted from the plurality of light sources 12 and has passed through light shield 14, and emits, toward the road opposite to the land, second emission light B which is included in the light emitted from the plurality of light sources 12 and has not passed through light shield 14. First emission light A which is included in light emitted from the plurality of light sources 12 and has passed through light shield 14 is light which does not include a portion of light having a predetermined wavelength. The light having a predetermined wavelength will be described later. Second emission light B which has not passed through light shield 14 is white light including light having a wavelength in a range from 380 nm or greater to 780 nm or less which is a visible wavelength.

[Characteristics of the Light Shield]

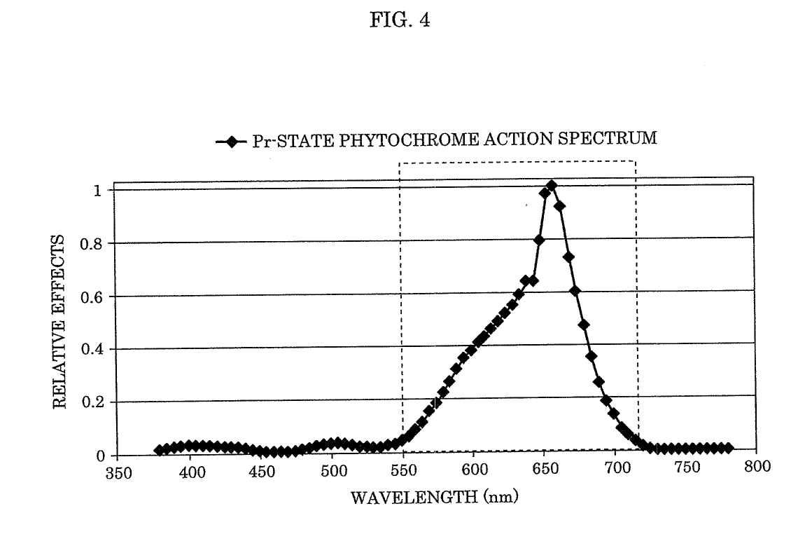

The following describes characteristics and a detailed configuration of light shield 14. FIG. 4 is a diagram indicating a wavelength region of light to which a Pr-state phytochrome reacts. In FIG. 4, the horizontal axis indicates wavelengths of light. The vertical axis indicates relative effects; that is, the ratio to which the Pr-state phytochrome reacts. It should be noted that the region enclosed by a dashed line indicates a wavelength region in which the relative effect is 0.04 or greater, with the relative effect of 0.04 at which the effect to photoperiodism sharply increases being a boundary.

Light shield 14 is a light shield for blocking a portion of light having a wavelength to which a Pr-state phytochrome reacts, as described above. The Pr-state phytochrome, as illustrated in FIG. 4, starts to react when light having a wavelength of approximately 550 nm is emitted, and reaches a peak of reaction when the wavelength is approximately 680 nm after the wavelength of emitted light gradually increases. The Pr-state phytochrome becomes less reactive as the wavelength of emitted light gradually increases, and does not react to light having a wavelength of 710 nm or greater. Accordingly, according to the present embodiment, the wavelength of light to which the Pr-state phytochrome reacts is a wavelength in a range from 550 nm or greater to 710 nm or less. Thus, light shield 14 may block at least a portion of light having a wavelength in a range from 550 nm or greater to 710 nm or less.

Light shield 14 is formed using, for example, an acrylic resin containing a dye or pigment which absorbs light having a wavelength in a range from 550 nm or greater to 710 nm or less described above. For example, a phthalocyanine compound, an indigo-based compound, etc., may be used as the dye or pigment which absorbs light having a wavelength in a range from 550 nm or greater to 710 nm or less. It should be noted that light shield 14 may be formed by applying the above-described dye or pigment which absorbs light having a wavelength in a range from 550 nm or greater to 710 nm or less, on a surface of a board having a plate-like shape and including light-transmissive property such as an acrylic resin or glass. In addition, light shield 14 may be formed by stacking a high refractive index material such as a titanium oxide and a low refractive index material such as a silicon oxide on the surface of the board having light-transmissive property such as an acrylic resin or glass, to form an optical multi-layer film which reflects the above-described light having a wavelength in a range from 550 nm or greater to 710 nm or less.

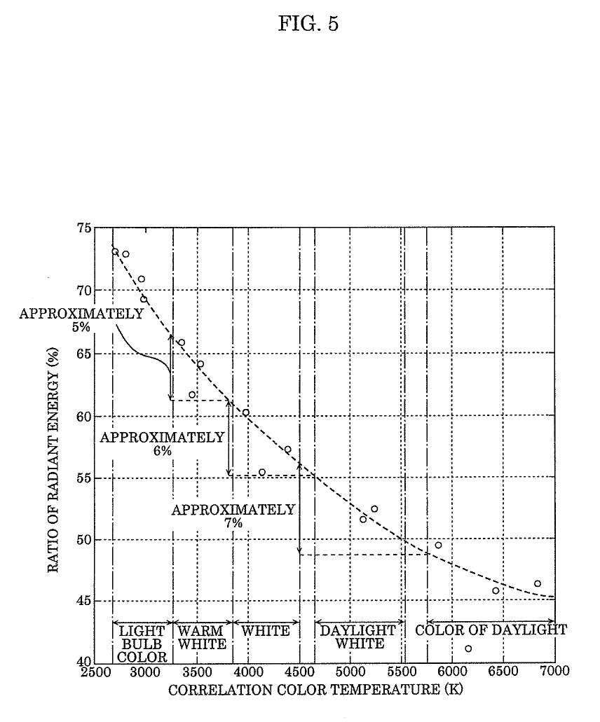

FIG. 5 is a diagram illustrating a ratio of light having a wavelength in a range from 550 nm or greater to 710 nm or less to radiant energy of total emission light, with respect to a correlated color temperature. In FIG. 5, the horizontal axis indicates a correlated color temperature. The vertical axis indicates a ratio of radiant energy of light having a wavelength in a range from 550 nm or greater to 710 nm or less, to radiant energy of total emission light (hereinafter simply referred to as “a ratio of radiant energy”).

The correlated color temperature is a parameter used as representing a light color of a light source, and is defined as an absolute temperature of blackbody radiation having chromaticity coordinates closest to uv chromaticity coordinates of the light source. The correlated color temperature is defined in JIS Z8113:1998, IEC60050-845, and so on. The correlated color temperature is, for example, a value obtained according to the measuring method of a correlated color temperature defined in JIS Z8725:1999. The chromaticity coordinates of the blackbody radiation closest to the chromaticity coordinates of the light source is obtained as an intersection point at the time when a perpendicular is drawn down from a point of the chromaticity coordinates of the light source to a blackbody radiation locus in chromaticity coordinates of CIE1960UCS (uniform chromaticity scale). In FIG. 5, the light-source color when the correlated color temperature is in a range from 2600 K to 3200 K is a light bulb color, the light-source color when the correlated color temperature is in a range from 3200 K to 3800 K is warm white, the light-source color when the correlated color temperature is in a range from 3800 K to 4500 K is white, the light-source color when the correlated color temperature is in a range from 4700 K to 5500 K is daylight white, and the light-source color when the correlated color temperature is in a range from 5750 K to 7000 K is a color of daylight.

As illustrated in FIG. 5, when the ratio of the radiant energy decreases by at least 5%, the light-source color changes to a color of a next-higher section. For example, the ratio of the radiant energy when the correlation color temperature is 3200 K that is the upper limit of the light bulb color is approximately 66%, and the ratio of the radiant energy when the correlation color temperature is 3800 K that is the upper limit of the warm white is approximately 61% that is approximately 5% lower than the ratio of the radiant energy when the correlation color temperature is 3200 K. In other words, by changing the light-source color to be at least in the next-higher section, it is possible to absorb the radiant energy of a wavelength in a range from 550 nm or greater to 710 nm or less, thereby enabling blocking a portion of the light having the wavelength. Thus, by decreasing the ratio of the radiant energy by at least 5%, it is possible to block a portion of the light having a wavelength in a range from 550 nm or greater to 710 nm or less.

Accordingly, first emission light A may have a light-source color in a section at least next-higher than the section of the light-source color of second emission light B. In addition, the ratio of the radiant energy of first emission light A may be lower by at least 5% than the ratio of the radiant energy of second emission light B. In this manner, first emission light A can be light which does not include a portion of light having a wavelength in a range from 550 nm or greater to 710 nm or less which is included by second emission light B.

It should be noted that, since light of a predetermined wavelength in second emission light B is not blocked, the correlated color temperature of second emission light B may be in a range from 2600 K or higher to 19000 K or lower which includes all of the sections of the light-source color. In this manner, the second emission light including all of the sections of the light-source color can be emitted to the road, and thus it is possible to ensure visibility of pedestrians and drivers.

As described above, light shield 14 is formed using, for example, a plate-like component which has a rectangular shape in the Y-Z plan view. The width of light shield 14 is greater than a width of any of the plurality of light sources 12, and light shield 14 has a height greater than a height of any of the plurality of light sources 12. It should be noted that, when light-emitting element 12a is covered by optical lens 12b in light source 12, the width of light shield 14 may be greater than a width of optical lens 12b, and light shield 14 may have a height greater than a height of optical lens 12b. When light-emitting element 12a is not covered by optical lens 12b in light source 12, the width of light shield 14 may be greater than a width of light-emitting element 12a, and light shield 14 may have a height greater than a height of light-emitting element 12a.

This increases the amount of light of emission light output from light source 12 and enters light shield 14, and thus it is possible to increase the amount of blocked light having a wavelength in a range from 550 nm or greater to 710 nm or less.

Light shield 14 may have a shape other than a rectangular shape in the Y-Z plan view. For example, light shield 14 may have a shape having one linear side and other sides being curved, a crescentic shape, for example, or may have any other shape.

[Emission Directions of Emission Light]

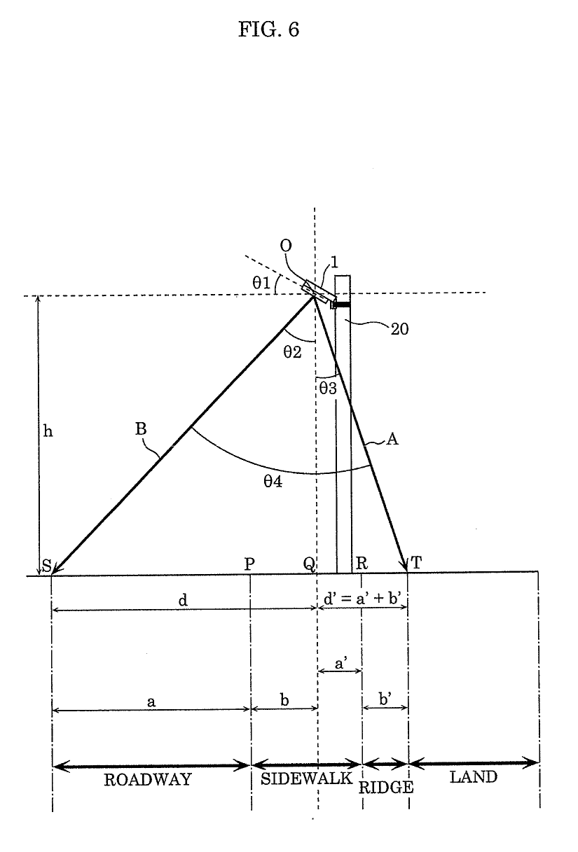

Next, emission directions of the first emission light and the second emission light will be described. FIG. 6 is a diagram illustrating an example of an emission direction of first emission light A and an emission direction of second emission light B of lighting apparatus 1 according to the embodiment.

FIG. 6 illustrates one of opposing lanes of a roadway, a sidewalk adjacent to the roadway, a ridge adjacent to the sidewalk, and land adjacent to the ridge, as an example of an environment in which lighting apparatus 1 is installed. The road according to the present embodiment includes the roadway, the sidewalk, and the ridge illustrated in FIG. 6. In addition, in the environment illustrated in FIG. 6, lighting apparatus 1 is attached to support column 20 installed on the sidewalk.

As illustrated in FIG. 6, lighting apparatus 1 is attached to support column 20 and illuminates the road. Accordingly, second emission light B which is included in light emitted from lighting apparatus 1 may be radiated to at least the whole area from a boundary between the land and the ridge, through the ridge, the sidewalk, to the width of the one of opposing lanes of a roadway. In addition, the land adjacent to the ridge may be irradiated with only first emission light A.

The following describes a position of support column 20 at which lighting apparatus 1 is attached. It should be noted that, FIG. 6 indicates an example of first emission light A which has passed through an end portion of light shield 14 in the height direction. In addition, FIG. 6 indicates an example of second emission light B which travels in the direction of the optical axis.

As illustrated in FIG. 6, a width of the one of opposing lanes of a roadway is denoted as a. A width from: a boundary (point P) between the one of opposing lanes of a roadway and the sidewalk; to a position (point Q) at which a center (point O) of a region in which a plurality of light sources 12 are linearly disposed in the direction X (see FIG. 3) in lighting apparatus 1 attached to support column 20 (hereinafter referred to as “center of lighting apparatus 1”) is projected perpendicularly downward is denoted as b. A width from the position (point Q) at which the center of lighting apparatus 1 is projected perpendicularly downward to the boundary (point R) between the sidewalk and the ridge is denoted as a′. A with of the ridge is denoted as b′. A width from an end (point S) of the one of opposing lanes of a roadway opposite to the sidewalk to the position (point Q) at which the center of lighting apparatus 1 is projected perpendicularly downward is denoted as d. A width from the position (point Q) at which the center of lighting apparatus 1 is projected perpendicularly downward to the boundary (point T) between the land and the ridge is denoted as d′ (=a′+b′). Minimum widths of the above-described widths are a=2 m, b=1 m, a′=0.5 m, b′=0.5 m, d=3 m, and d′=1 m which are calculated based on Government Order on Road Design Standards.

As to a height of lighting apparatus 1 attached to support column 20, a height from the surface of the road to the center (point O) of lighting apparatus 1 is denoted as h. In the case where lighting apparatus 1 is a security lamp, h=4.5 m.

Lighting apparatus 1 is attached to support column 20 such that the direction in which the plurality of light sources 12 are linearly disposed forms angle θ1 with a horizontal direction. In addition, lighting apparatus 1 is attached to support column 20 such that lighting cover 16 of lighting apparatus 1 is located on a lower side (road side) than housing 10. At this time, second emission light B is emitted toward the road, and first emission light A is emitted toward the land. In addition, on the basis (0 degree) of the position (point Q) at which the center of lighting apparatus 1 is projected perpendicularly downward, an angle at which second emission light B emits light to the end (point S) of the one of opposing lanes of a roadway opposite to the sidewalk is an angle θ2. It should be noted that, it is desirable that luminosity of second emission light B emitted in the direction from lighting apparatus 1 to the end (point S) of the one of opposing lanes of a roadway opposite to the sidewalk is the maximum luminosity, and thus the direction in which second emission light B is emitted from lighting apparatus 1 to the end (point S) of the one of opposing lanes of a roadway opposite to the sidewalk is called a maximum luminosity direction. In addition, on the basis (0 degree) of the position (point Q) at which the center of lighting apparatus 1 is projected perpendicularly downward, an angle at which first emission light A emits light to the boundary (point T) between the land and the ridge is an angle θ3. Furthermore, a sum of angle θ2 and angle θ3 is θ4. Angle θ4 is an emission angle of first emission light A with respect to the maximum luminosity direction.

In consideration of the minimum widths based on the above-described Government Order on Road Design Standards, it is sufficient that 01=30 degrees, θ2=approximately 56 degrees, θ3=approximately 13 degrees, and θ4=approximately 70 degrees, for emitting first emission light A to the land, and emitting second emission light B to the range from the center of the roadway to the boundary between the land and the ridge. In other words, the area of the land is an area in which the emission angle with respect to the maximum luminosity direction is 70 degrees or greater. Accordingly, first emission light A may be emitted to cover at least an area in which the emission angle is 70 degrees or greater with respect to the maximum luminosity direction. In this manner, the land is irradiated with only first emission light A without being irradiated with second emission light B. Thus, since crops are not irradiated with second emission light B, it is possible to suppress light pollution that affects the crops.

It should be noted that the above-described specific numerical values of parameters are mere examples, and thus the numerical values are not limited and may be changed as necessary.

As described above, with lighting apparatus 1 according to the present embodiment, light shield 14 blocks a portion of light having a predetermined wavelength to which the Pr-state phytochrome reacts, crops are irradiated with only first emission light A, and not irradiated with second emission light B. It is thus possible to suppress light pollution that affects the crops. Furthermore, since second emission light B light which includes the portion of light having the predetermined wavelength is emitted to the road, it is possible to ensure visibility of pedestrians and drivers.

### Modification 1

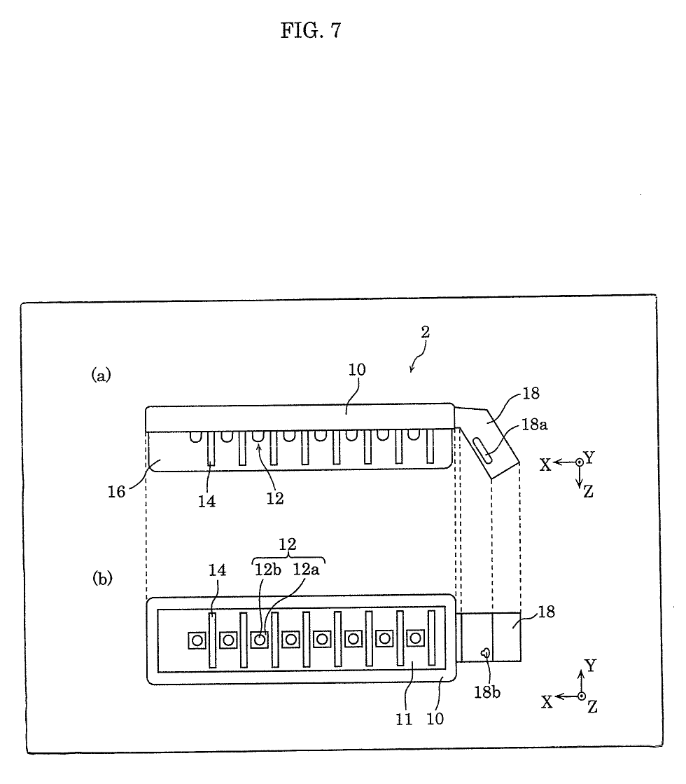

Next, Modification 1 of the embodiment will be described. FIG. 7 is a schematic view illustrating a configuration of lighting apparatus 2 according to Modification 1, showing a front view in (a) and a bottom view in (b). It should be noted that illustration of lighting cover 16 is omitted in (b) of FIG. 7.

Lighting apparatus 2 according to Modification 1 differs from lighting apparatus 1 according to the embodiment, in that light shield 14 is provided to each of a plurality of light sources 12.

More specifically, as illustrated in FIG. 7, lighting apparatus 2 includes housing 10, board 11, a plurality of light sources 12, and light shield 14, as with lighting apparatus 1 described in the embodiment. Light shield 14 is provided for each of the plurality of light sources 12. In other words, light source 12 and light shield 14 form a pair. Light shield 14 is disposed on the land side with respect to light source 12.

In this manner, lighting apparatus 2 includes light source 12 at an end closest to the road, and light shield 14 at an end closest to the land opposite to the road side. When light shield 14 is disposed at least on the land side, light shield 14 blocks a portion of light which is included in the light emitted from light source 12 to crops, and has a wavelength in a range from 550 nm or greater to 710 nm or less. It is thus possible to emit, toward the land, only first emission light A which does not include the portion of light having the above-described wavelength. In this manner, occurrence of light pollution that affects the crops can be suppressed.

As described above, with lighting apparatus 2 according to the present modification, each of light shields 14 which forms a pair with a corresponding one of the plurality of light sources 12 blocks a portion of light having a wavelength in a range from 550 nm or greater to 710 nm or less, and thus it is possible to more reliably block the portion of light having the above-described wavelength. In this manner, occurrence of light pollution that affects the crops can be more reliably suppressed.

### Modification 2

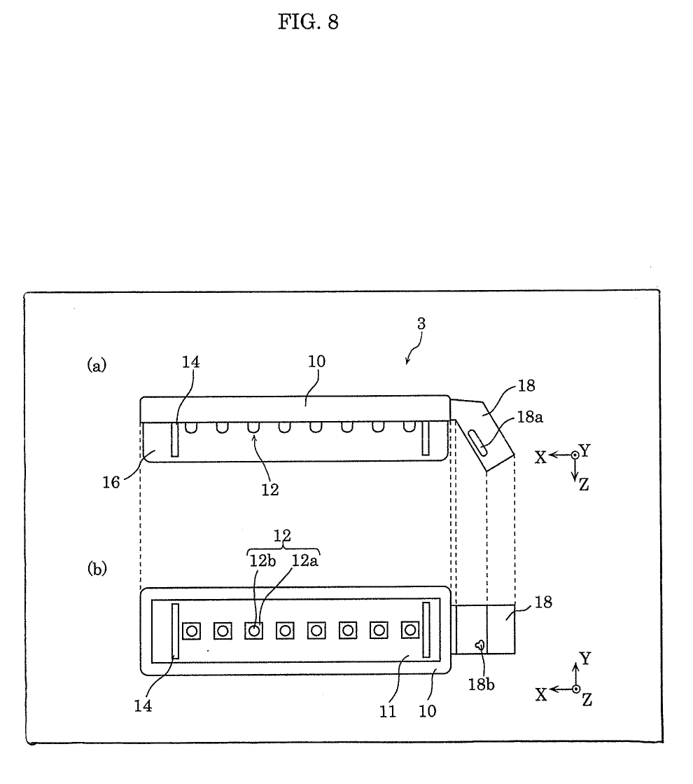

Next, Modification 2 of the embodiment will be described. FIG. 8 is a schematic view illustrating a configuration of lighting apparatus 3 according to Modification 2, showing a front view in (a) and a bottom view in (b). It should be noted that illustration of lighting cover 16 is omitted in (b) of FIG. 8.

Lighting apparatus 3 according to Modification 2 differs from lighting apparatus 1 according to the embodiment, in that light shields 14 are provided to sandwich a region in which a plurality of light sources 12 are linearly disposed.

More specifically, as illustrated in FIG. 8, lighting apparatus 3 includes housing 10, board 11, a plurality of light sources 12, and light shields 14, as with lighting apparatus 1 described in the embodiment. Here, light shield 14 is disposed closer to the road than light source 12 that is disposed closest to the road among a plurality of light sources 12, and is disposed closer to the land than light source 12 that is disposed closest to the land among the plurality of light sources 12, to sandwich the region in which the plurality of light sources 12 are linearly disposed.

In this manner, it is possible to block a target portion of light included in light emitted from all of the plurality of light sources 12, using light shields 14. Accordingly, it is possible to decrease the number of light shields 14 disposed on lighting apparatus 3, and efficiently block a portion of light having a wavelength in a range from 550 nm or greater to 710 or less using a smaller number of light shields 14. In addition, since it is possible to decrease the number of light shields 14, costs can be reduced.

As described above, with lighting apparatus 3 according to the present modification, it is possible to reduce light pollution that affects crops, by efficiently blocking, using a smaller number of light shields 14, a portion of light having a wavelength in a range from 550 nm or greater to 710 nm or less.

### Advantageous Effects, Etc.

As described above, the lighting apparatus according to the embodiment is a lighting apparatus to be installed in an area adjacent to land. The lighting apparatus includes: a plurality of light sources disposed on a board; and a light shield which blocks a portion of light emitted from the plurality of light sources, the portion of light having a predetermined wavelength, wherein the light shield is disposed on the board closer to the land than at least a light source disposed closest to the land among the plurality of light sources, and has a shape which (i) sends, to the land, first emission light included in the light emitted from the plurality of light sources, and (ii) avoids sending, to the land, second emission light included in the light emitted from the plurality of light sources, the first emission light having passed through the light shield, the second emission light not having passed through the light shield.

In this manner, since the light shield blocks a portion of light having a predetermined wavelength to which the Pr-state phytochrome reacts, crops are not irradiated with the second emission light. It is thus possible to suppress light pollution that affects the crops. Furthermore, since the second emission light which includes the portion of light having the predetermined wavelength is emitted to the road, it is possible to ensure visibility of pedestrians and drivers.

In addition, as with lighting apparatus 1 described in the above-described embodiment, the predetermined wavelength may be in a range from 550 nm or greater to 710 nm or less.

The portion of light having a wavelength in a range from 550 nm or greater to 710 nm or less is a portion of light to which the Pr-state phytochrome reacts. Accordingly, it is possible to suppress light pollution that affects the crops, by blocking the portion of light having the wavelength in the range from 550 nm or greater to 710 nm or less.

In addition, the lighting apparatus may include an attaching component at one end closest to the land, the attaching component being for attaching the lighting apparatus to a support column. The light shield may have a width greater than a width of any of the plurality of light sources, in a direction orthogonal to a direction from the one end of the lighting apparatus closest to the land toward the other end at which the attaching component is not disposed.

In addition, the light shield may have a height greater than a height of any of the plurality of light sources.

This increases the amount of light of emission light output from the light source and enters the light shield, and thus it is possible to increase the amount of blocked light having a predetermined wavelength.

In addition, a correlated color temperature of the second emission light may be in a range from 2600 K or higher to 19000 K or lower.

With this, since a portion of light having a predetermined wavelength in the second emission light is not blocked, the correlated color temperature of the second emission light may be in a range from 2600 K or higher to 19000 K or lower which includes all of the sections of the light-source color. In this manner, the second emission light including all of the sections of the light-source color can be emitted to the road, and thus it is possible to ensure visibility of pedestrians and drivers.

In addition, the first emission light may have a light-source color in a section at least next-higher than a section of a light-source color of the second emission light.

In addition, a ratio of radiant energy of the first emission light may be lower by at least 5% than a ratio of radiant energy of the second emission light.

In this manner, the first emission light can be light which does not include a portion of light having a predetermined wavelength which is included by the second emission light.

In addition, the light shield may include a plurality of light shields corresponding one to one to the plurality of light sources.

In this manner, since the light source and the light shield form a pair, a portion of light which is emitted from the light source and has a predetermined wavelength is blocked by the light shield included in the pair. Accordingly, it is possible to more reliably block a portion of light having the predetermined wavelength. Thus, occurrence of light pollution that affects the crops can be more reliably suppressed.

In addition, the light shield may include a plurality of light shields, each of the plurality of light shields provided between adjacent ones of the plurality of light sources.

In this manner, it is possible to block a portion of light which is emitted from a plurality of light sources and has a predetermined wavelength, in proximity to the plurality of light sources.

In addition, the light shield may include a plurality of light shields, the plurality of light shields sandwiching a region in which the plurality of light sources are linearly disposed.

In this manner, it is possible to block a target portion of light included in light emitted from all of the plurality of light sources, using the light shields. Accordingly, it is possible to decrease the number of the light shields disposed on the lighting apparatus, and efficiently block a portion of light having a predetermined wavelength, using a smaller number of the light shields.

In addition, the first emission light may be emitted toward the land to cover at least an area in which an emission angle of the first emission light with respect to a maximum luminosity direction of the second emission light is 70 degrees or greater.

In this manner, the land is irradiated with only the first emission light without being irradiated with the second emission light. Thus, since the crops are not irradiated with the second emission light, it is possible to suppress light pollution that affects the crops.

In addition, a height direction of the light shield may be parallel to an optical axis direction of the plurality of light sources.

In this manner, it is possible to emit light which includes the portion of light having the predetermined wavelength, at least in the direction of the optical axis of the light source.

In addition, the plurality of light sources may each include a light-emitting element and an optical lens, and the light-emitting element may be covered by the optical lens.

In this manner, the light source is capable of emitting light not only in the optical axis direction but also in the direction perpendicular to the optical axis and other directions.

In addition, the second emission light, not having passed through the light shield, may include the portion of the light having the predetermined wavelength.

In addition, the light shield may comprise a plurality of light shields corresponding one to one to the plurality of light sources, each of the plurality of light shields being closer to the land than the corresponding one of the plurality of light sources.

In addition, the light shield may comprise a plurality of light shields, and a number of the plurality of light shields may be greater than a number of the plurality of light sources.

In addition, the plurality of light sources may be disposed linearly on the board, the light shield may comprise a plurality of light shields, the plurality of light shields may be disposed linearly on the board, and the plurality of light sources may be interleaved between the plurality of light shields.

In addition, the light shield may include a phthalocyanine compound or an indigo-based compound.

In addition, the light shield may comprise a multi-layer film including a low refractive index material and a high refractive index material.

In addition, the light shield may have a shape other than a rectangular shape.

### Other Modifications, Etc.

Although a lighting apparatus according to the embodiment of the present disclosure has been described thus far, the present disclosure is not limited to the above-described embodiment.

For instance, the light shield may have any shape. The light shield may have a shape which fits to a size and a shape of the inside of the lighting cover, for example. More specifically, the light shield may have a rectangular shape when the lighting cover is rectangular. When the lighting cover has a curved shape, the light shield may have a curved shape to fit to a curve of the lighting cover.

In addition, the number of the light shields and the number of the light sources are not limited to the numbers described above, and may be changed.

Furthermore, the type of the light-emitting element is not limited to the LED, and other light source may be used as the light source. In addition, the light source may have a configuration in which the light-emitting element is covered by the optical lens, or may have a configuration in which the optical lens is not included.

Furthermore, although the height direction of the light shield is parallel to the direction of the optical axis according to the above-described modification of the embodiment, the height direction of the light shield may be a direction having an angle with respect to the direction of the optical axis. For example, the light shield may be disposed to incline toward the road with respect to the optical axis. In this manner, the second emission light can be emitted more accurately to the road side, and thus it is possible to further suppress emitting the second emission light to the land.

In addition, the numbers used in the above-described embodiment and modifications are each an example for specifically explaining the present disclosure, and thus the present disclosure is not limited by the examples of the numbers.

It should be noted that the present disclosure also includes other forms in which various modifications apparent to those skilled in the art are applied to the embodiment or forms in which structural components and functions in the embodiment, modifications, and examples are arbitrarily combined within the scope of the present disclosure.

While the foregoing has described one or more embodiments and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present teachings.

What is claimed is:

1. A lighting apparatus to be installed in an area adjacent to land, the lighting apparatus comprising:
a plurality of light sources disposed on a board; and
a light shield which blocks a portion of light emitted from the plurality of light sources, the portion of light having a predetermined wavelength, wherein
the light shield
is disposed on the board closer to the land than at least a light source disposed closest to the land among the plurality of light sources, and
has a shape which (i) sends, to the land, first emission light included in the light emitted from the plurality of light sources, and (ii) avoids sending, to the land, second emission light included in the light emitted from the plurality of light sources, the first emission light having passed through the light shield, the second emission light not having passed through the light shield.

2. The lighting apparatus according to claim 1, wherein
the predetermined wavelength is in a range from 550 nm or greater to 710 nm or less.

3. The lighting apparatus according to claim 1, comprising:
an attaching component at one end closest to the land, the attaching component being for attaching the lighting apparatus to a support column, wherein
the light shield has a width greater than a width of any of the plurality of light sources, in a direction orthogonal to a direction from the one end of the lighting apparatus closest to the land toward an other end at which the attaching component is not disposed.

4. The lighting apparatus according to claim 1, wherein
the light shield has a height greater than a height of any of the plurality of light sources.

5. The lighting apparatus according to claim 1, wherein
a correlated color temperature of the second emission light is in a range from 2600 K or higher to 19000 K or lower.

6. The lighting apparatus according to claim 1, wherein
the first emission light has a light-source color in a section at least next-higher than a section of a light-source color of the second emission light.

7. The lighting apparatus according to claim 1, wherein
a ratio of radiant energy of the first emission light is lower than a ratio of radiant energy of the second emission light by at least 5%.

8. The lighting apparatus according to claim 1, wherein
the light shield comprises a plurality of light shields corresponding one to one to the plurality of light sources.

9. The lighting apparatus according to claim 1, wherein
the light shield comprises a plurality of light shields, each of the plurality of light shields provided between adjacent ones of the plurality of light sources.

10. The lighting apparatus according to claim 1, wherein
the light shield comprises a plurality of light shields, the plurality of light shields sandwiching a region in which the plurality of light sources are linearly disposed.

11. The lighting apparatus according to claim 1, wherein
the first emission light is emitted toward the land to cover at least an area in which an emission angle of the first emission light with respect to a maximum luminosity direction of the second emission light is 70 degrees or greater.

12. The lighting apparatus according to claim 1, wherein
a height direction of the light shield is parallel to an optical axis direction of the plurality of light sources.

13. The lighting apparatus according to claim 1, wherein
the plurality of light sources each include a light-emitting element and an optical lens, and
the light-emitting element is covered by the optical lens.

14. The lighting apparatus according to claim 1, wherein
the second emission light, not having passed through the light shield, includes the portion of the light having the predetermined wavelength.

15. The lighting apparatus according to claim 1, wherein
the light shield comprises a plurality of light shields corresponding one to one to the plurality of light sources, each of the plurality of light shields being closer to the land than the corresponding one of the plurality of light sources.

16. The lighting apparatus according to claim 1, wherein
the light shield comprises a plurality of light shields, and
a number of the plurality of light shields is greater than a number of the plurality of light sources.

17. The lighting apparatus according to claim 1, wherein
the plurality of light sources are disposed linearly on the board,
the light shield comprises a plurality of light shields,
the plurality of light shields are disposed linearly on the board, and
the plurality of light sources are interleaved between the plurality of light shields.

18. The lighting apparatus according to claim 1, wherein
the light shield includes a phthalocyanine compound or an indigo-based compound.

19. The lighting apparatus according to claim 1, wherein
the light shield comprises a multi-layer film including a low refractive index material and a high refractive index material.

20. The lighting apparatus according to claim 1, wherein
the light shield has a shape other than a rectangular shape.
